(19) United States
(12) Patent Application Publication
(10) Pub. No.: US 2024/0190712 A1
(43) Pub. Date: Jun. 13, 2024

(54) NANO-SILICON AGGLOMERATE COMPOSITE NEGATIVE ELECTRODE MATERIAL AND METHOD FOR PREPARING THE SAME

(71) Applicant: TOMI(CHENGDU) APPLIED TECHNOLOGY RESEARCH INSTITUTE COMPANY LIMITED, CHENGDU CITY, SICHUAN (CN)

(72) Inventors: Weijie YU, CHENGDU CITY,SICHUAN (CN); Si-Chung CHANG, CHENGDU CITY, SICHUAN (CN); Fusheng LI, CHENGDU CITY, SICHUAN (CN); Chang ZHAO, CHENGDU CITY, SICHUAN (CN); Xuezhi DAI, CHENGDU CITY, SICHUAN (CN); Xiaobing CHEN, CHENGDU CITY, SICHUAN (CN); Yang YU, CHENGDU CITY, SICHUAN (CN)

(73) Assignee: TOMI(CHENGDU) APPLIED TECHNOLOGY RESEARCH INSTITUTE COMPANY LIMITED, CHENGDU CITY, SICHUAN (CN)

(21) Appl. No.: 17/904,171

(22) PCT Filed: Aug. 3, 2021
(86) PCT No.: PCT/CN2021/110204

§ 371 Date: Aug. 12, 2022

(30) Foreign Application Priority Data
Mar. 3, 2021 (CN) 202110235883.4

(51) Int. Cl. C01B 33/033; H01M 4/02; H01M 4/36; H01M 4/38; H01M 4/48; H01M 4/583

(52) U.S. Cl. CPC C01B 33/033; H01M 4/366; H01M 4/386; H01M 4/48; H01M 4/583; C01P 2002/72; C01P 2004/03; C01P 2004/30; C01P 2004/61; C01P 2004/84; C01P 2006/40; H01M 2004/021; H01M 2004/027

(57) ABSTRACT

The invention provides a nano-silicon agglomerate composite negative electrode material of pine needle and branch-shaped three-dimensional network structure and a method for preparing the same. The nano-silicon agglomerate composite negative electrode material comprises nano-sized core particles, a nano-silicon agglomerate of pine needle and branch-shaped three-dimensional network structure growing around the nano-sized core particles, and a composite coating layer over the nano-silicon agglomerate of needles and branch-shaped three-dimensional network structure. With measurements, it is shown that the nano-silicon agglomerate composite negative electrode material, when being applied in lithium ion battery, has excellent battery charge-discharge cycle performances and rate capability, and it has an initial discharge capacity per gram of more than 2600 mAh/g, and an initial coulombic efficiency of no less than 85%.

### TECHNICAL FIELD

The invention relates to the technical field of lithium battery materials, in particular to a nano-silicon agglomerate composite negative electrode material and a method for preparing the same.

### BACKGROUND OF THE INVENTION

A silicon-based negative electrode material has an ultrahigh theoretical capacity of up to 4200 mAh/g, and the raw material silicon used in the silicon-based negative electrode material is particularly abundant in natural resources, low in cost and environment-friendly. Moreover, the silicon-based negative electrode material has low intercalation/deintercalation lithium potentials (˜0.4 V vs. Li/Li⁺), and thus upon full battery charging, lithium dendrites are not ready to form on the surface of the silicon-based negative electrode material. Hence, the safety performances of the silicon-based negative electrode material are superior to those of graphite negative electrode materials. Based on the above advantages, the silicon-based negative electrode material is well known as a most promising negative electrode material of novel high-capacity lithium ion batteries.

However, current silicon-based negative electrode materials, due to their fatal defects, are difficult to be put into practical uses. When silicon is used as a negative electrode material in a lithium battery, the crystalline silicon, after lithium intercalation, expands 3 to 4 times in its volume, and after lithium deintercalation, the volume will vigorously shrink. Batteries, after multiple cycles, will lead to serious pulverization of silicon particles, formation of new interfaces, continuous fracture and regeneration of SEI films, and rapid consumption of lithium in electrolytes. All the defects will result in a rapid decay in the capacity of the batteries. Existing material compounding and coating technologies cannot solve the fatal defect that the discharge capacities of batteries using a silicon-based negative electrode material will rapidly decay.

Additionally, the silicon-based negative electrode materials only have an electric conductivity of 6.7×10⁻⁴ S/cm, and the conductivity is very poor, which also seriously influences the electrochemical performances of batteries. Due to the above defects, practical applications of the silicon-based negative electrode materials in the field of lithium ion battery are greatly restricted. Presently used silicon-carbon cathode materials are formed by compounding about 10% of silicon with a graphite negative electrode, and the capacity of the compounded silicon-carbon negative electrode is only about 500 mAh/g, which is far lower than the theoretical capacity of the silicon-based cathode materials.

A novel silicon nanowire cluster material formed by one-dimensional silicon nanowires has larger spaces in the wire clusters, and the silicon nanowires have a diameter of less than 100 nm. When the material is used as a negative electrode material, the volume will expand upon lithium intercalation, and there are enough spaces in the silicon nanowire cluster to tolerate such expansion. This material is a known material. When such one-dimensional silicon nanowires wind and agglomerate, Si—Si covalent bond connections are absent between wires and there are no riveting points. Hence, such silicon nanowire cluster, when being used as a negative material of lithium batteries, is easily crushed in a process of rolling electrode sheets. While the material can tolerate the volume expansion upon lithium intercalation and the volume shrinkage upon lithium intercalation, due to the absence of riveting points between silicon nanowires, the nanowires cannot well contact with each other, leading to poor electrical contacts, and thus it is very difficult for electrons to migrate from the nanowires to a copper foil collector.

Methods for preparing silicon nanowires comprises a laser ablation method, a thermal evaporation method, a hydrothermal method, a metal-assisted chemical etching Method (MACE), a CVD method and the like. These existing methods have the problems of high raw material costs, extremely low manufacture efficiencies, serious chemical pollution and the like, and their industrial mass productions cannot be realized.

Document 1 (Zhang Zheng, Shandong University Master's Degree Theses, 2012.05, “Preparation of Silicon Nanowires and Nanotubes and Studies on Their Related Physical Properties”) reports that metallic zinc powder and SiCl₄ are used to prepare silicon nanowires in a sealed stainless steel container at high temperatures. What are acquired in the document are needle-shaped silicon nanowires having a micrometer length, and no wire cluster is formed. In the document, the preparation environment is completely static and there is no connection between the obtained silicon nanowires. Since the preparation uses a container that is pressure resistant and completely sealed, and thus continuous industrial production cannot be realized.

Reference 2 (“Microclusters of Kinked Silicon Nanowires Synthesized by a Recyclable Iodide Process for High-Performance Lithium-Ion [symbol] Anodes, Adv. Energy Mater. 2020, 2002108) reported that silicon nanowire clusters are formed by decomposing Sil₄ at high vacuum (<1.33 Pa) and high temperature (900° C.). As can be clearly seen from the SEM (Scanning Electron Microscope) photographs in the document, the silicon nanowire clusters are loose silicon nanowire clusters formed by winding one-dimensional silicon nanowires. The one-dimensional silicon nanowires have no branching, forking and connecting structures. In the process described in this document, the reactant Sil₄ is in a gas phase at a high temperature of 900° C., and only at a high vacuum condition of <1.33 Pa, the decomposition reaction of the Sil₄ can be thermodynamically performed. Since the reactant is in a gas phase, in order to keep the pressure in the reaction vessel to be less than 1.33 Pa, the amount of the charged reactant must be controlled to be very small. Otherwise, the pressure will exceed 1.33 Pa, the decomposition reaction cannot be performed. Hence, this reaction is extremely low in the efficiency, and its industrial production cannot be realized.

Document 3 (CN105271235A) discloses a silicon nanowire material and a method for preparing the same, wherein a copper-based catalyst and silicon are preheated in the inert atmosphere at 200-500° C., to obtain a contact mass, and then the contact mass is reacted with chloromethane whilst the silicon is controlled to be not completely reacted; impurities in the reactants are removed, and unreacted silicon is separated; thereby, the one-dimensional silicon nanowires are obtained; the one-dimensional silicon nanowires do not have any branching and forking structures. In the document, the method for removing impurities (carbon deposition) and separating unreacted silicon in the reactants is described below: the products are heated to 500° C. by charging air in a tubular furnace and calcined for one hour to remove deposited carbon; during the procedure, a majority of the carbon nanowires are oxidized to produce silicon dioxide; subsequently, a sodium hydroxide solution is used to remove the silicon dioxide; the resultant silicon nanowires, due to the radius of less than 100 nm, have high chemical activities, and thus they can be also dissolved in the sodium hydroxide solution. For this method, even if the silicon nanowires are obtained, the yield is very low because that a large quantity of silicon is removed for being oxidized and dissolved. The method described in the document uses acid washing and base washing steps, and thus large quantities of waste water will be yielded. This method, due to low yields and productions of substantial acidic and alkaline industrial waste water, cannot be used in industrial productions.

Document 4 (US20150072233A1) discloses a negative active material, where one-dimensional silicon-based nanowires are grown on the surface of spherical particles (having a diameter of 1 to 30 μm) of non-carbonaceous conductive metals, crystalline silicon or alloys, the one-dimensional silicon-based nanowires being in a portion of 1 to 40 wt %, and then, they are externally covered by a layer of amorphous carbon, wherein at least 50% of the one-dimensional silicon-based nanowires are covered by the amorphous carbonaceous coating layer. The document defines the silicon-based nanowires as follows (see paragraph 0043): at least a portion may be linear, gently or sharply curved, or branched. A layer of the silicon-based nanowires (1 to 50 wt %) is statically grown on the surface of the micrometer non-carbonaceous conductive particles, and more than 50% of the silicon nanowires are covered by the amorphous carbon. Hence, the negative active material recited in the document has the following structure: the inner core comprises spherical (having a diameter of 1 to 30 μm) non-carbonaceous conductive metals, crystalline silicon or alloys; the second layer comprises one-dimensional silicon-based nanowires, the one-dimensional silicon-based nanowires having no wire-wire node or less wire-wire nodes; because the connecting state is almost absent between the nanowires, rapid migration of electrons is difficult and it should be assisted with an electrically conducting agent. More than 50% of the outer layer are covered by amorphous carbon, and thus a majority of the surface morphology of the composite particles is amorphous carbon. In the negative material, the silicon-based nanowire accounts for 1 to 40 wt %, and thus it is not the main phase.

Document 5 (CN 103035915) discloses a negative active material, in which a layer of one-dimensional nanowires is grown on a spherical carbonaceous base material having a diameter of about 1 to about 30 μm by using a vapor-liquid-solid (VLS) growth method, wherein the weight of the one-dimensional silicon-based nanowires accounts for 1 to 40 wt %. Hence, the negative active material comprises carbon as the main phase, and the silicon-based nanowires as the secondary phase, and it is a carbon-silicon-based nanowire composite negative material. The document defines the silicon-based nanowires as follows: the term “nanowire” refers to a wire structure having a nano-diameter cross-section, and at least a portion may be linear, gently or sharply curved, or branched. In other word, the nanowires in the document are not in a multi-connection and multi-node network structure. Due to the absence of the connecting state between nanowires, rapid migration of electrons is difficult and it should be assisted with an electrically conducting agent. In the examples disclosed in the document, the maximum initial capacity per gram of the negative active material is less than 670 mAh/g. This occurs for the reason that the main phase of the negative material is carbon, while the silicon nanowires, as the secondary phase, are in a low amount.

As can be seen from the SEM photographs of silicon nanowires reported by all published literature documents, in a static state, the silicon nanowires grow along the direction of crystal plane, and with the outer layer being Si-Ox, they grow into a one-dimensional linear structure. During the one-dimensional linear growth of the silicon nanowires, only when impurity atoms are deposited in the nanowires, a turning phenomenon will occur. Hence, a forking phenomenon is rarely observed.

Document 6 (CN 106941153A) discloses a method where a plasma torch is used to heat highly pure silicon to form highly pure gaseous silicon that, after condensation, could produce a cottony elemental silicon nanowire cluster, and then the silicon nanowire cluster is compounded and carbonized with a medium-high molecular polymer at a carbonization temperature of 900 to 1600° C. for 2 to 24 hours. At above 900° C., such silicon nanowires are very ready to react with amorphous carbon obtained from the cleavage of the middle-high molecular polymer to produce silicon carbide. The morphologies of the silicon nanowires have not been observed in FIG. 5 to FIG. 7 in the description of this document. Additionally, as can be seen from FIG. 1 of the description, what is prepared is a one-dimensional linear material which forms a very loose agglomerate structure with no connection between wires. In this case, due to the absence of the connecting state between the silicon nanowires, rapid migration of electrons is difficult and it should be assisted with an electrically conducting agent. Additionally, the cycling curve of the sample button cell as shown in FIG. 3 of the description should involve fluctuations in discharge capacity, and it is unlikely a standard liner line.

Therefore, there is currently an urgent need for a high-performance nano silicon-based negative electrode material product that is not in a one-dimensional loose state, which can be manufactured in mass productions by low-cost, high-efficiency, clean and continuous production technologies.

### SUMMARY OF THE INVENTION

The invention is aimed to solve a technical problem that the silicon-based negative electrode material, when being applied in a lithium battery, would have poor cycling performances, low charge and discharge capacities, and low initial coulombic efficiencies.

The invention is aimed to solve another technical problem that when preparing a silicon-based negative electrode material based on silicon nanowires, the dispersing performances of the silicon nanowire are poor, the electrical conductivity of silicon nanowire clusters is poor, and the silicon nanowire clusters, upon rolling of electrode sheets, are ready to be crushed.

The invention is aimed to solve a further technical problem of realizing wastewater-free, continuous and low-cost industrial manufacture of a nano-silicon agglomerate composite negative electrode material.

The invention solves the above-described problems through the following technical solutions.

Provided is a nano-silicon agglomerate composite negative electrode material comprising nano-sized core particles, a nano-silicon agglomerate of pine needle and branch-shaped three-dimensional network structure growing around the nano-sized core particles, and a composite coating layer over the nano-silicon agglomerate of pine needle and branch-shaped three-dimensional network structure, wherein the nano-sized core particles comprise metal particles and/or carbon particles; the nano-silicon agglomerate of pine needle and branch-shaped three-dimensional network structure is formed by interconnected silicon nanowires having a diameter of 50 to 150 nm and a length of 0.5 to 2 μm; and the composite coating layer comprises electrically conductive carbon and an inorganic metal oxide.

In one exemplary embodiment, the metal particles are particles of at least one selected from the group consisting of silver, copper, iron, nickel, and cobalt.

In one exemplary embodiment, the inorganic metal oxide includes titanium dioxide and/or zirconium dioxide.

In one exemplary embodiment, based on the weight of the nano-silicon agglomerate composite negative electrode material, the nano-silicon agglomerate of pine needle and branch-shaped three-dimensional network structure is present in an amount of 90.6 to 96.17 wt %.

In one exemplary embodiment, based on the weight of the nano-silicon agglomerate composite negative electrode material, the nano-sized core particles are present in an amount of 1.4 to 3.3% by weight, wherein the metal particles are present in an amount of 0 to 2.6% by weight, and the carbon particles are present in an amount of 0 to 2.7% by weight.

In one exemplary embodiment, based on the weight of the nano-silicon agglomerate composite negative electrode material, the composite coating layer is present in an amount of 2.1 to 7.0% by weight, wherein in the composite coating layer, the electrically conductive carbon is present in an amount of 1.0 to 4.5% by weight, and the inorganic metal oxide is present in an amount of 1.0 to 3.0% by weight.

In one exemplary embodiment, the nano-silicon agglomerate composite negative electrode material has an average particle size of 5 to 20 μm.

In one exemplary embodiment, in the nano-silicon agglomerate of pine needle and branch-shaped three-dimensional network structure, chemical cross-linking is formed between at least a portion of the silicon nanowires, for example to form Si—Si covalent bonding.

Also provided is a method for preparing the above-described nano-silicon agglomerate composite negative electrode material, which comprises the following steps:
(1) performing a surface metal replacement reaction by placing a powder of metal A in a salt solution of metal B, to partially produce nano-sized metal B particles on a part of the surface of the powder of metal A, thereby forming a composite powder;
(2) continuously charging the composite powder serving as a reactant and a nucleating agent into a reaction chamber;
(3) carrying a SiCl₄ gas into the reaction chamber with inert gas or nitrogen;
(4) performing a high temperature reaction with continuous stirring by setting the temperature of the reaction chamber to be 500 to 950° C., the reaction causing a nano-silicon agglomerate of pine needle and branch-shaped three-dimensional network structure to dynamically grow and wind around the nano-sized metal B particles;
(5) subjecting the nano-silicon agglomerate of pine needle and branch-shaped three-dimensional network structure discharged from the reaction chamber to a vacuum thermal treatment; and
(6) subjecting the nano-silicon agglomerate of pine needle and branch-shaped three-dimensional network structure obtained in step (5) to a composite coating treatment with electrically conductive carbon and an inorganic metal oxide.

In one exemplary embodiment, in step (1), the surface metal replacement reaction is performed by placing an alloy powder comprising metal A and carbon in the salt solution of metal B; on a part of the surface of the alloy powder, the nano-sized metal B particles are generated, to form a composite powder; in step (4), the reaction causes the nano-silicon agglomerate of pine needle and branch-shaped three-dimensional network structure to wind and grow on the nano-sized carbon particles produced by the alloy powder and around the nano-sized metal B particles.

In one exemplary embodiment, the metal A is at least one selected from the group consisting of magnesium and zinc, and the metal B is at least one selected from the group consisting of silver, copper, iron, nickel, and cobalt.

In one exemplary embodiment, the inorganic metal oxide includes titanium dioxide and/or zirconium dioxide.

In one exemplary embodiment, the vacuum thermal treatment of step (5) and the composite coating treatment of step (6) are performed simultaneously.

In one exemplary embodiment, the composite coating treatment includes applying an organic titanium source and/or an organic zirconium source, and applying an organic carbon source to the nano-silicon agglomerate of pine needle and branch-shaped three-dimensional network structure, through high-temperature hydrolysis, to form a composite coating layer of titanium dioxide and/or zirconium dioxide, and carbon.

Also provided is another method for preparing the above-described nano-silicon agglomerate composite negative material, which comprises the following steps:
(1) continuously charging an alloy powder comprising metal A and carbon and serving as a reactant and a nucleating agent into a reaction chamber;
(2) carrying a SiCl₄ gas into the reaction chamber with inert gas or nitrogen;
(3) performing a high temperature reaction with continuous stirring by setting the temperature of the reaction chamber to be 500 to 950° C., the reaction causing a nano-silicon agglomerate of pine needle and branch-shaped three-dimensional network structure to wind and grow on the nano-sized carbon particles produced by the alloy powder;
(4) subjecting the nano-silicon agglomerate of pine needle and branch-shaped three-dimensional network structure discharged from the reaction chamber to a vacuum thermal treatment; and
(5) subjecting the nano-silicon agglomerate of pine needle and branch-shaped three-dimensional network structure obtained in step (4) to a composite coating treatment with electrically conductive carbon and an inorganic metal oxide.

In one exemplary embodiment, the metal A is at least one selected from the group consisting of magnesium and zinc.

In one exemplary embodiment, the inorganic metal oxide includes titanium dioxide and/or zirconium dioxide.

In one exemplary embodiment, the vacuum thermal treatment of step (4) and the composite coating treatment of step (5) are performed simultaneously.

In one exemplary embodiment, the composite coating treatment includes applying an organic titanium source and/or an organic zirconium source, and applying an organic carbon source to the nano-silicon agglomerate of pi6ne needle and branch-shaped three-dimensional network structure, through high-temperature hydrolysis, to form a composite coating layer of titanium dioxide and/or zirconium dioxide, and carbon.

At the high temperature of step (4), the metal A having a low boiling point and a high vapor pressure is rapidly vaporized, and the vaporized metal A reacts with the gas phase SiCl₄ to produce silicon and a chloride of the metal A. In the high-temperature reaction chamber, only the nano-sized carbon particles (if present) and the nano-sized metal B particles (if present) are remained in the alloy powder and the composite powder after the volatilization of the metal A. It should be noted that as a nucleating agent, at least one of the nano-sized carbon particles and the nano-sized metal B particles must be present. With the particles as the core, the silicon generated in the gas phase can rapidly generate silicon nanowires. Under the action of continuous high-speed stirring in a boiling state, with carbon (if present) and metal B (if present) as cores, they wind to form interconnected nano-silicon agglomerates of pine needle and branch-shaped three-dimensional network structure. The nano-silicon agglomerates of pine needle and branch-shaped three-dimensional network structure are continuously and spirally discharged. The generated chloride of the metal A, due to its low boiling point, is discharged form a chimney and condensed to form a byproduct. In the step (5), the vacuum heat treatment is performed to completely remove the residual chloride of the metal A by volatilization.

It should be particularly noted that the invention is concerned to a nano-silicon agglomerate of pine needle and branch-shaped three-dimensional network structure dynamically grown on dynamic nucleating sources (nano-sized silver, copper, iron, nickel, cobalt, carbon particles), which is completely different from complete and long one dimensional linear silicon nanowires in the prior arts (e.g., documents 1 to 6 mentioned in the background) that are statically grown on static nucleating sources. FIG. 1A is a schematic diagram of the silicon nanowire clusters prepared in a static state reported in the documents, wherein the one-dimensional grown silicon nanowires wind and wire-wire connections are absent. FIG. 1B is a schematic diagram of the nano-silicon agglomerate of pine needle and branch-shaped three-dimensional network structure prepared in the dynamic state disclosed in the present invention, wherein pine needles and pine needles, and pine needles and pine branches are interconnected. The SEM photograph of a real sample (e.g., FIG. 2) disclosed in the present invention shows that between pine needles and between pend needles and pine branches, the connecting states are closer. FIG. 1C is the schematic diagram for the connecting states between pine needles and between pine needles and pine branches in the nanowire agglomerate disclosed in the present invention, wherein pine needles and pine needles, and pine needles and pine branches are structurally connected.

In a boiling reaction system with high-speed stirring, a spatial heterophase dynamic growth is performed to generate pine needle and branch-shaped nano-silicon agglomerates with nano-sized electrically conductive metal particles and nano-sized carbon particles (if present) as the core, wherein pine needles and pine needles, and pine needles and pine branches are interconnected (e.g., chemical crosslinking) to form a three-dimensional network structure. The three-dimensional network structure has certain compressive strength and good electric conduction state.

The nano-silicon agglomerate of pine needle and branch-shaped three-dimensional network structure prepared in the invention is micron-sized, and it solves the problem that nano silicon has poor dispersibility and it is difficult to uniformly disperse it in N-methylpyrrolidone in a slurry-forming step of a negative electrode material.

The nano-silicon agglomerate of pine needle and branch-shaped three-dimensional network structure prepared in the present invention is completely different from one-dimensional silicon nanowires and silicon nanowire clusters disclosed in the prior arts (e.g., documents 1 to 6) in the morphology. The one-dimensional silicon nanowires disclosed in the prior arts are rarely wire-wire connected, while the nano-silicon agglomerate of pine needle and branch-shaped three-dimensional network structure of the present invention is characterized in that pine needles and pine needles, and pine needles and pine branches are interconnected to form a multi-node three-dimensional network structure. The multi-node three-dimensional network structure can provide great helps for increasing the compressive strength of powder particles upon rolling of electrode sheets and for increasing the electron migration of nano silicon upon lithium intercalation/deintercalation. In addition, the key for forming such unique nano-silicon agglomerates of pine needle and branch-shaped three-dimensional network structure in an interconnection state resides in that a very fine nucleating source formed in the reaction system is always agitated at a high speed and the silicon nanowires are grown in a dynamic state, not as described in the prior arts, grown in a static state.

On the surface of the nano-silicon agglomerate of pine needle and branch-shaped three-dimensional network structure prepared in the present invention, a composite coating of electrically conductive carbon and an inorganic metal oxide is applied, to prevent the occurrence of adverse side reactions between silicon and electrolyte, and further optimize the dispersibility and the electrical conductivity.

In the nano-silicon agglomerate composite negative electrode material prepared in the present invention, the nano-silicon agglomerate of pine needle and branch-shaped three-dimensional network structure account for 90.6 to 96.17% by weight, i.e., the nano silicon is the main phase. Thus, the composite negative electrode materials obtained as such have a higher discharge capacity per gram and they are more beneficial for improving the energy density of a lithium battery.

### Advantageous Effects of the Invention

The nano-silicon agglomerate composite negative electrode material and the method for preparing the same provided by the present invention have the following beneficial effects:
(1) the material has excellent battery charge-discharge cycle performances and rate capability; the initial discharge capacity per gram is more than 2600 mAh/g, and the initial coulombic efficiency is no less than 85%;
(2) the nano-silicon agglomerate of pine needle and branch-shaped three-dimensional network structure has a micron-sized near spherical morphology, and the product has good workability for electrode sheets;
(3) the nano-silicon agglomerate composite negative electrode material is dynamically produced wherein pine needles and pine needles, and pine branches and pine needles are interconnected to form a multi-node network. The material, upon rolling of electrode sheets, is not ready to be crushed; upon battery charge and discharge, due to the complete connecting state between pine needles and pine needles and between pine branches and pine needles, it is easy for electrons to migrate, and thus the agglomerate has good electron conductivity;
(4) continuous feeding and discharging can realize continuous productions and high production efficiencies;
(5) low costs: no silicon source loses, and the SiCl₄ raw materials used are byproducts in the polysilicon industry, and the raw material cost is low; the process has a low sintering temperature, short time, and low energy consumptions, and the overall production is low in cost;
(6) environmental friendliness: the produced chloride byproduct is in a gas phase at high temperatures and it is completely condensed into a byproduct after being volatilized from a reaction furnace; no emission of wastewater and waste gas occurs in the manufacturing process.

### BRIEF DESCRIPTION OF THE DRAWINGS

In order to understand the invention better and to show how to accomplish the invention, now, by referring to the drawings, the embodiments of the invention will be described only by the means of exemplification, in which:

FIG. 1 is a control schematic diagram for the silicon nanowire clusters (A) reported in the prior art documents and the nano-silicon agglomerate (B) of pine needle and branch-shaped three-dimensional network structure disclosed in the present invention application and connecting states of pine needles-pine needles and pine needles-pine branches (C) therein;

FIG. 2 is a SEM photograph of the nano-silicon agglomerate of pine needle and branch-shaped three-dimensional network structure with silver as the core particles prepared in Example 1 (magnification: 10,000, scale in the figure: 2 μm);

FIG. 3 is an XRD pattern of the nano-silicon agglomerate of pine needle and branch-shaped three-dimensional network structure with silver as the core particles prepared in Example 1;

FIG. 4 is an initial charge-discharge curve of a button cell comprising the nano-silicon agglomerate composite negative electrode material prepared in Example 1;

FIG. 5 is a cycle curve for a button cell comprising the nano-silicon agglomerate composite negative electrode material prepared in Example 1;

FIG. 6 is a SEM photograph of the nano-silicon agglomerate of pine needle and branch-shaped three-dimensional network structure with copper as the core particles prepared in Example 2 (magnification: 5,000, scale in the figure: 5 μm);

FIG. 7 is an XRD pattern of the nano-silicon agglomerate of pine needle and branch-shaped three-dimensional network structure with copper as the core particles prepared in Example 2;

FIG. 8 is an initial charge-discharge curve of a button cell comprising the nano-silicon agglomerate composite negative electrode material prepared in Example 2;

FIG. 9 is a cycle curve of a button cell comprising the nano-silicon agglomerate composite negative electrode material prepared in Example 2;

FIG. 10 is an initial charge-discharge curve of button cell comprising the nano-silicon agglomerate composite negative electrode material prepared in Example 3;

FIG. 11 is an initial charge-discharge curve of a button cell comprising the nano-silicon agglomerate composite negative electrode material prepared in Example 4;

FIG. 12 is an initial charge-discharge curve of a button cell comprising the nano-silicon agglomerate composite negative electrode material prepared in Example 5;

FIG. 13 is a SEM photograph of the negative electrode material prepared in Comparative Example 1 (magnification: 3,000, scale in the figure: 8 μm);

FIG. 14 is a SEM photograph of the negative electrode material prepared in Comparative Example 2 (magnification: 5,000, scale in the figure: 5 μm).

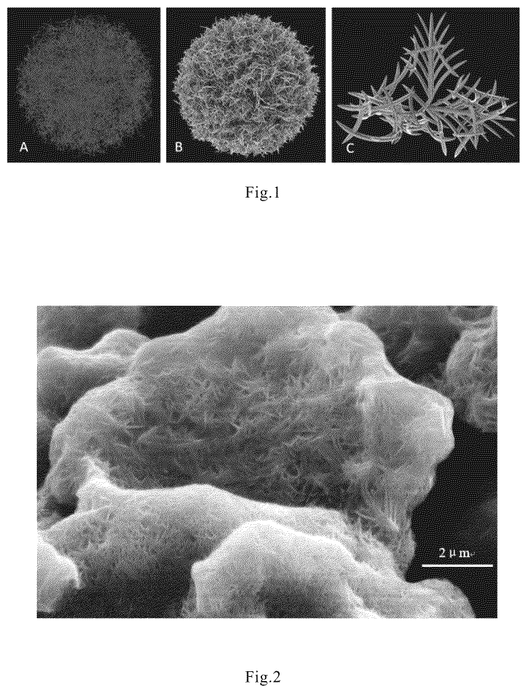

### DETAILED DESCRIPTION OF THE EMBODIMENTS

The present invention will be further illustrated with reference to the following specific examples. It should be understood that these examples are only illustrative for the invention but not limitative for the scope of the invention. The invention may be reflected in many different forms, but not being limited to the examples illustrated herein.

In the following examples, experimental methods that are not specified with particular conditions are typically performed according to conventional conditions or conditions recommended by manufacturers. Unless specified otherwise, all percentages, ratios, proportions, or parts are by weight. Unless defined otherwise, all the technical and scientific terms used herein have the same meanings as commonly understood by one of ordinary skill in the art. Besides, any methods and materials similar or equivalent to those described herein can be used in the method of the invention. The preferred embodiments and materials described herein are only for exemplification.

All the numbers indicating dimensions, physical characteristics, processing parameters, constituent quantities, and reaction conditions and the like used in the description and claims should be understood to be modified with the term “about” in any case.

It should be understood that all the ranges disclosed here encompass the beginning values of the ranges and the end values thereof, and any and all subranges contained therein. For example, the range of “1 to 10” should be considered to include any and all the subranges between (and including) the minimum value 1 and the maximum value 10, i.e., all subranges beginning with the minimum value 1 or more and ended with the maximum value 10 or less, e.g., from 1 to 2, from 3 to 5, from 8 to 10, etc.

### Example 1

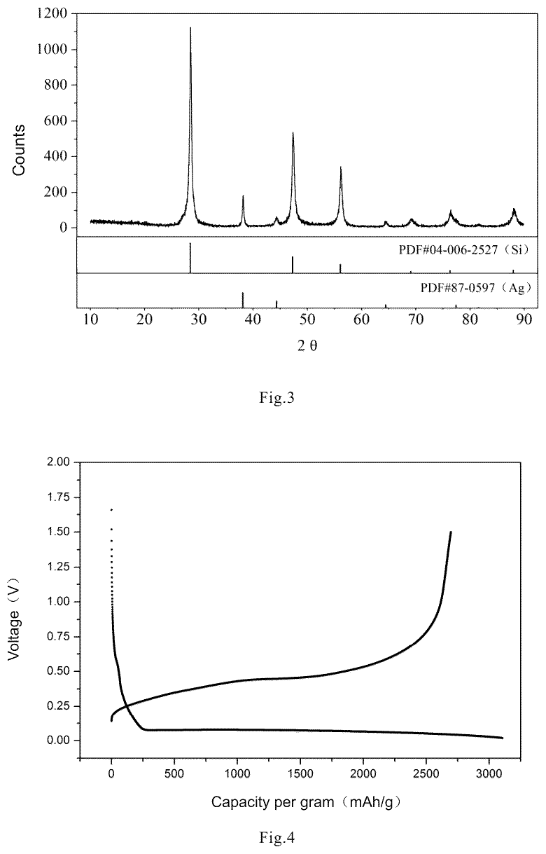

10 kg of 200-mesh zinc powder with a purity of 99.9% were added into 10 L of a 0.05 M silver nitrate solution, and they were stirred for 30 minutes at 5° C. and left to stand for 1 hour. Then, the underlying material was taken out, and it is centrifugally dried and then vacuum dried by baking at 80° C., to produce zinc powder coated with silver on a part of the surface, with a silver content of 0.54 wt %. The temperature of a stirring boiling furnace (fluidized bed) was set to 550° C. A spiral feeder was used to feed the above prepared silver-coated zinc powder into the boiling furnace at a constant feeding speed of 2 kg/h. 13 kg of analytically pure silicon tetrachloride were added into a silicon tetrachloride volatilizer, and the volatilizer was heated in a water bath set at the temperature of 55° C., which is close to the boiling point 57.6° C. of the silicon tetrachloride. An argon gas with a high purity of 99.995% was supplied into the silicon tetrachloride volatilizer in order to carry the gaseous silicon tetrachloride into the boiling furnace. By adjusting the flow rate of the carrier argon gas, the feeding speed of the silicon tetrachloride was controlled to be 2.6 kg/h. The rotational speed of the stirring blade of the stirring boiling furnace was set at 60 rpm. The boiling furnace was maintained at a positive pressure of 1,500 Pa, and when the pressure was higher than the positive pressure, an electromagnetic valve arranged at the chimney was automatically opened. Products were continuously and spirally discharged from the lower part of the boiling furnace. After reactions were performed for 3 hours with continuous feeding, the discharge was started to obtain a dark yellow-green powder containing a small amount of zinc chloride. FIG. 2 was the SEM photograph of the powder, and the photograph clearly showed the micron-sized agglomerate of pine needle and branch-shaped three-dimensional network structure formed with silicon nanowires, wherein the silicon nanowires had a diameter of about 100 nm and a length of about 1 μm. FIG. 3 was an X-ray diffraction spectrum of the powder, showing that the powder was crystalline silicon containing a small amount of silver. The prepared agglomerate powder was measured with a laser particle size analyzer to have a particle size distribution: D10=5.8 μm, D50=10.5 μm, D90=14.3 μm.

The above powder was sprayed with a dispersion of butyl titanate/carboxymethyl cellulose in ethanol, and after being dried by baking in vacuum, it was added into a vacuum furnace. The furnace was charged with a highly pure argon gas, then heated to 500° C., further evacuated to 100 Pa, and further heated to 700° C. The temperature was then kept for 4 hours so that the small amount of zinc chloride was completely removed by evacuation. Meanwhile, the butyl titanate was cracked into titanium dioxide, and the carboxymethyl cellulose was cracked into carbon. The titanium dioxide and the carbon were coated over the nano-silicon agglomerates of pine needle and branch-shaped three-dimensional network structure, to produce a composite negative electrode material, wherein the amounts of the titanium dioxide and carbon for surface coating and the inner core silver particles were 1.0%, 1.2% and 2.5% respectively.

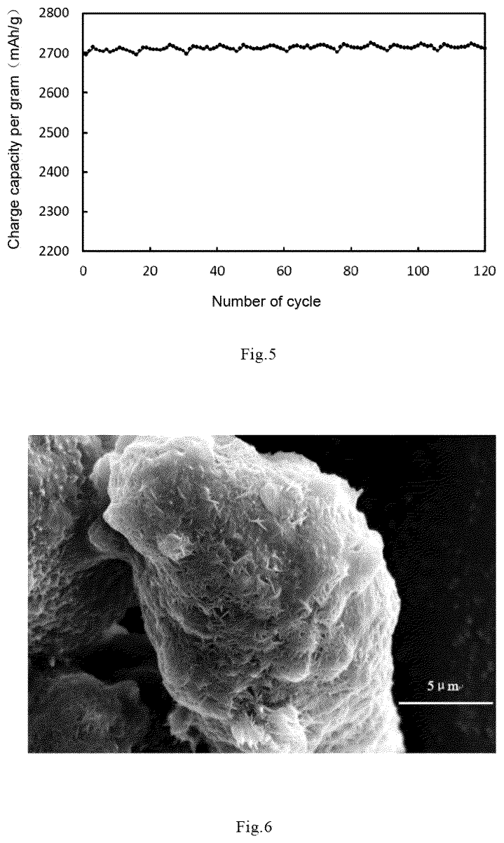

0.4 g of SuperP electrically conductive carbon powder, 15 g of a polyamide acid-based binder (with a solid content of 14.2%), 27 g of a carbon nanotube/graphene mixed slurry (with a solid content of 5.6%), and 15 g of the above prepared composite negative electrode material, by adding N-methylpyrrolidone, were stirred to obtain a uniform slurry with a viscosity of 3,800 mPa·s. The slurry was coated on a 10 μm copper foil. The coating layer had a wet thickness of 150 μm, and it was vacuum dried by baking at 100° C., rolled, and subjected to imidization at 290° C. for 30 minutes in an argon atmosphere. Then, a CR2032 button cell was fabricated using metallic lithium as the counter electrode, Celgard 2400 as the separator, and 1M LiPF₆/EC+DEC as the electrolyte, and it was measured with its electrochemical properties. FIG. 4 is the initial charge-discharge curve of the button cell; FIG. 5 is the cycling curve for the button cell. The nano-silicon agglomerate composite negative electrode material prepared in Example 1 has an initial discharge capacity per gram of 3,105.8 mAh/g, and an initial coulombic efficiency of 86.8%. The button cell was cycled for 120 times through 1C charge-discharge cycle, and the charge capacity was hardly decayed.

### Example 2

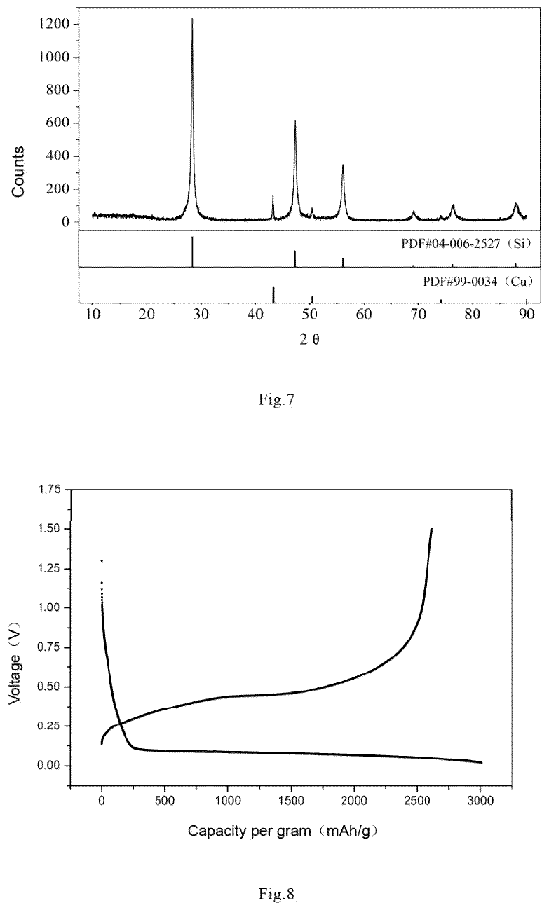

10 kg of 100-mesh zinc powder with a purity of 99.9% were added into 10 L of a 0.05 M copper nitrate solution, and they were stirred for 20 minutes at 2° C. and left to stand for 1 hour. Then, the underlying material was taken out, and it is centrifugally dried and then vacuum dried by baking at 80° C., to produce zinc powder coated with copper on a part of the surface, with a copper content of 0.32 wt %. The temperature of a stirring boiling furnace was set to 650° C. A spiral feeder was used to feed the above prepared copper-coated zinc powder into the boiling furnace at a constant feeding speed of 2 kg/h. 13 kg of analytically pure silicon tetrachloride were added into a silicon tetrachloride volatilizer, and the volatilizer was heated in a water bath set at the temperature of 55° C., which is close to the boiling point 57.6° C. of the silicon tetrachloride. An argon gas with a high purity of 99.995% was supplied into the silicon tetrachloride volatilizer in order to carry the gaseous silicon tetrachloride into the boiling furnace. By adjusting the flow rate of the carrier argon gas, the feeding speed of the silicon tetrachloride was controlled to be 2.6 kg/h. The rotational speed of the stirring blade of the stirring boiling furnace was set at 100 rpm. The boiling furnace was maintained at a positive pressure of 1,500 Pa, and when the pressure was higher than the positive pressure, an electromagnetic valve arranged at the chimney was automatically opened. Products were continuously and spirally discharged from the lower part of the boiling furnace. After reactions were performed for 3 hours with continuous feeding, the discharge was started to obtain a dark yellow-green powder containing a small amount of zinc chloride. FIG. 6 was the SEM photograph of the powder, and the photograph clearly showed the micron-sized agglomerate of pine needle and branch-shaped three-dimensional network structure formed with silicon nanowires, wherein the silicon nanowires had a diameter of about 90 nm and a length of about 1 μm. FIG. 7 was an X-ray diffraction spectrum of the powder, showing that the powder was crystalline silicon. A small amount of copper as the core particles, for the low amount, was not detected due to the limitation of the sensitivity of X-ray diffraction meter. The prepared agglomerate powder was measured with a laser particle size analyzer to have a particle size distribution: D10=5.1 μm, D50=9.6 μm, D90=12.7 μm.

The above powder was sprayed with a dispersion of butyl zirconate/carboxymethyl cellulose in ethanol, and after being dried by baking in vacuum, it was added into a vacuum furnace. The furnace was charged with a highly pure argon gas, then heated to 500° C., further evacuated to 100 Pa, and further heated to 750° C. The temperature was then kept for 4 hours so that the small amount of zinc chloride was completely removed by evacuation. Meanwhile, the butyl zirconate was cracked into zirconium dioxide, and the carboxymethyl cellulose was cracked into carbon. The zirconium dioxide and the carbon were coated over the nano-silicon agglomerates of pine needle and branch-shaped three-dimensional network structure, to produce a composite negative electrode material, wherein the amounts of the zirconium dioxide and carbon for surface coating and the inner core copper particles were 1.2%, 1.5% and 1.4% respectively.

0.4 g of SuperP electrically conductive carbon powder, 15 g of a polyamide acid-based binder (with a solid content of 14.2%), 27 g of a carbon nanotube/graphene mixed slurry (with a solid content of 5.6%), and 15 g of the above prepared composite negative electrode material, by adding N-methylpyrrolidone, were stirred to obtain a uniform slurry with a viscosity of 3,800 mPa·s. The slurry was coated on a 10 μm copper foil. The coating layer had a wet thickness of 150 μm, and it was vacuum dried by baking at 100° C., rolled, and subjected to imidization at 290° C. for 30 minutes in an argon atmosphere. Then, a CR2032 button cell was fabricated using metallic lithium as the counter electrode, Celgard 2400 as the separator, and 1M LiPF₆/EC+DEC as the electrolyte, and it was measured with its electrochemical properties. FIG. 8 is the initial charge-discharge curve of the button cell; FIG. 9 is the cycling curve for the button cell. The nano-silicon agglomerate composite negative electrode material prepared in Example 2 has an initial discharge capacity per gram of 3,009.8 mAh/g, and an initial coulombic efficiency of 86.9%. The button cell was cycled for 115 times through 1C charge-discharge cycle, and the charge capacity was hardly decayed.

### Example 3

10 kg of 50-mesh zinc powder with a carbon content of 0.5% were added into 10 L of a 0.02 M silver nitrate solution, and they were stirred for 30 minutes at 0° C. and left to stand for 1 hour. Then, the underlying material was taken out, and it is centrifugally dried and then vacuum dried by baking at 80° C., to produce carbon-containing zinc powder coated with silver on a part of the surface, with a silver content of 0.216 wt %. The temperature of a stirring boiling furnace was set to 750° C. A spiral feeder was used to feed the above prepared silver-coated carbon-containing zinc powder into the boiling furnace at a constant feeding speed of 2 kg/h. 13 kg of analytically pure silicon tetrachloride were added into a silicon tetrachloride volatilizer, and the volatilizer was heated in a water bath set at the temperature of 55° C., which is close to the boiling point 57.6° C. of the silicon tetrachloride. An argon gas with a high purity of 99.995% was supplied into the silicon tetrachloride volatilizer in order to carry the gaseous silicon tetrachloride into the boiling furnace. By adjusting the flow rate of the carrier argon gas, the feeding speed of the silicon tetrachloride was controlled to be 2.6 kg/h. The rotational speed of the stirring blade of the stirring boiling furnace was set at 80 rpm. The boiling furnace was maintained at a positive pressure of 1,500 Pa, and when the pressure was higher than the positive pressure, an electromagnetic valve arranged at the chimney was automatically opened. Products were continuously and spirally discharged from the lower part of the boiling furnace. After reactions were performed for 3 hours with continuous feeding, the discharge was started to obtain a dark yellow-green powder containing a small amount of zinc chloride. The powder also was a nano-silicon agglomerate of pine needle and branch-shaped three-dimensional network structure, wherein the silicon nanowires had a diameter of about 100 nm and a length of about 1 μm. The X-ray diffraction spectrum showed that the powder was crystalline silicon. With small amounts of silver and carbon as the inner core particles, the XRD spectrum shows the presence of silver, but fails to show the presence of carbon. A carbon analyzer was used to measure the carbon content to be 2.37%. The prepared agglomerate powder was measured with a laser particle size analyzer to have a particle size distribution: D10=5.4 μm, D50=10.2 μm, D90=14.0 μm.

The above powder was sprayed with a dispersion of isopropyl titanate/sucrose in ethanol, and after being dried by baking in vacuum, it was added into a vacuum furnace. The furnace was charged with a highly pure argon gas, then heated to 500° C., further evacuated to 100 Pa, and further heated to 750° C. The temperature was then kept for 4 hours so that the small amount of zinc chloride was completely removed by evacuation. Meanwhile, the isopropyl titanate was cracked into titanium dioxide, and the sucrose was cracked into carbon. The titanium dioxide and the carbon were coated over the nano-silicon agglomerates of pine needle and branch-shaped three-dimensional network structure, to produce a composite negative electrode material, wherein the amounts of the titanium dioxide and carbon for surface coating and the carbon and silver contained in the inner silver particles were 1.2%, 1.5%, 2.3% and 1.0% respectively.

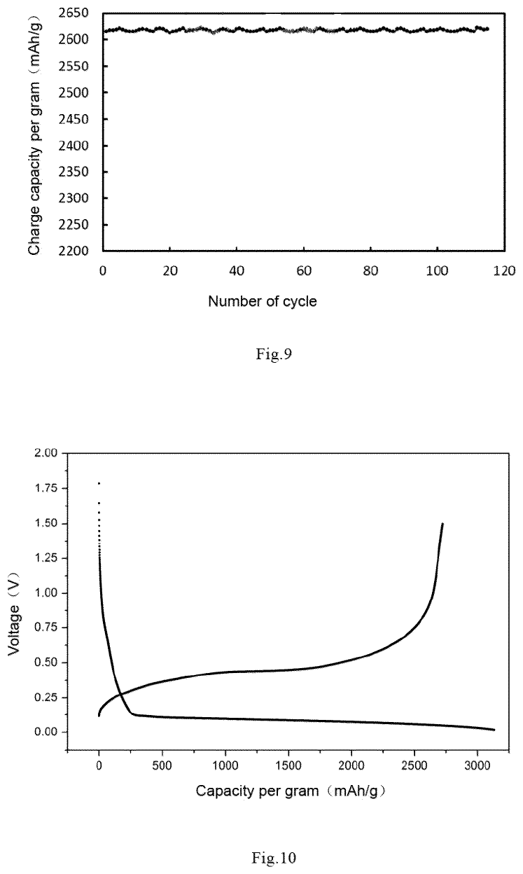

0.4 g of SuperP electrically conductive carbon powder, 15 g of a polyamide acid-based binder (with a solid content of 14.2%), 27 g of a carbon nanotube/graphene mixed slurry (with a solid content of 5.6%), and 15 g of the above prepared composite negative electrode material, by adding N-methylpyrrolidone, were stirred to obtain a uniform slurry with a viscosity of 3,800 mPa·s. The slurry was coated on a 10 μm copper foil. The coating layer had a wet thickness of 150 μm, and it was vacuum dried by baking at 100° C., rolled, and subjected to imidization at 290° C. for 30 minutes in an argon atmosphere. Then, a CR2032 button cell was fabricated using metallic lithium as the counter electrode, Celgard 2400 as the separator, and 1M LiPF₆/EC+DEC as the electrolyte, and it was measured with its electrochemical properties. FIG. 10 is the initial charge-discharge curve of the button cell. The nano-silicon agglomerate composite negative electrode material prepared in Example 3 has an initial discharge capacity per gram of 3,132.5 mAh/g, and an initial coulombic efficiency of 87.0%. The button cell was cycled for 115 times through 1C charge-discharge cycle, and the charge capacity was not decayed.

### Example 4

10 kg of 300-mesh zinc powder with a carbon content of 0.5% were taken, and the temperature of a stirring boiling furnace was set to 600° C. A spiral feeder was used to feed the above carbon-containing zinc powder into the boiling furnace at a constant feeding speed of 2 kg/h. 13 kg of analytically pure silicon tetrachloride were added into a silicon tetrachloride volatilizer, and the volatilizer was heated in a water bath set at the temperature of 55° C., which is close to the boiling point 57.6° C. of the silicon tetrachloride. An argon gas with a high purity of 99.995% was supplied into the silicon tetrachloride volatilizer in order to carry the gaseous silicon tetrachloride into the boiling furnace. By adjusting the flow rate of the carrier argon gas, the feeding speed of the silicon tetrachloride was controlled to be 2.6 kg/h. The rotational speed of the stirring blade of the stirring boiling furnace was set at 120 rpm. The boiling furnace was maintained at a positive pressure of 1,500 Pa, and when the pressure was higher than the positive pressure, an electromagnetic valve arranged at the chimney was automatically opened. Products were continuously and spirally discharged from the lower part of the boiling furnace. After reactions were performed for 3 hours with continuous feeding, the discharge was started to obtain a dark yellow-green powder containing a small amount of zinc chloride. The SEM photograph showed the nano-silicon agglomerate of pine needle and branch-shaped three-dimensional network structure, wherein the silicon nanowires had a diameter of about 80 nm and a length of about 1 μm. The X-ray diffraction spectrum showed that the powder was crystalline silicon. The small amount of carbon as the core particles, for the low amount, was not detected due to the limitation of the sensitivity of X-ray diffraction meter. A carbon analyzer was used to measure the carbon content to be 2.32%. The prepared agglomerate powder was measured with a laser particle size analyzer to have a particle size distribution: D10=4.7 μm, D50=9.2 μm, D90=12.0 μm.

The above powder was sprayed with a dispersion of butyl titanate/carboxymethyl cellulose in ethanol, and after being dried by baking in vacuum, it was added into a vacuum furnace. The furnace was charged with a highly pure argon gas, then heated to 500° C., further evacuated to 100 Pa, and further heated to 700° C. The temperature was then kept for 4 hours so that the small amount of zinc chloride was completely removed by evacuation. Meanwhile, the butyl titanate was cracked into titanium dioxide, and the carboxymethyl cellulose was cracked into carbon. The titanium dioxide and the carbon were coated over the nano-silicon agglomerates of pine needle and branch-shaped three-dimensional network structure, to produce a composite negative electrode material, wherein the amounts of the titanium dioxide and carbon for surface coating and the inner core carbon particles were 1.0%, 1.2%, and 2.3% respectively.

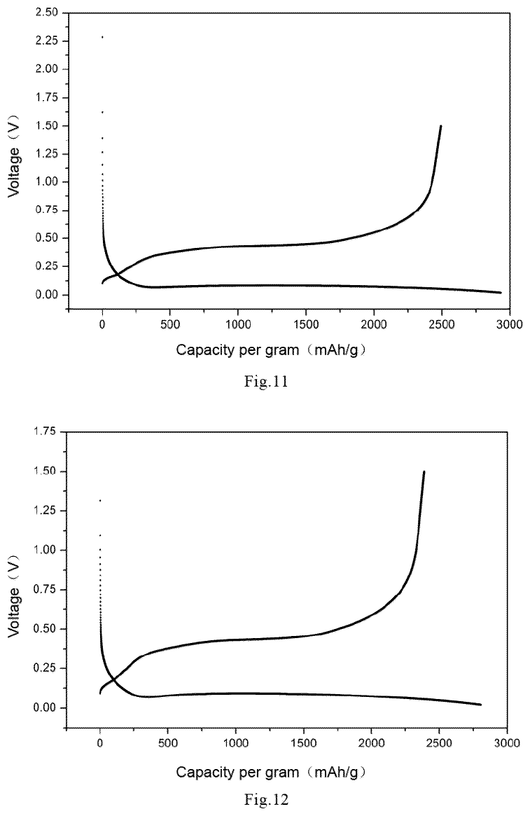

0.4 g of SuperP electrically conductive carbon powder, 15 g of a polyamide acid-based binder (with a solid content of 14.2%), 27 g of a carbon nanotube/graphene mixed slurry (with a solid content of 5.6%), and 15 g of the above prepared composite negative electrode material, by adding N-methylpyrrolidone, were stirred to obtain a uniform slurry with a viscosity of 3,800 mPa·s. The slurry was coated on a 10 μm copper foil. The coating layer had a wet thickness of 150 μm, and it was vacuum dried by baking at 100° C., rolled, and subjected to imidization at 290° C. for 30 minutes in an argon atmosphere. Then, a CR2032 button cell was fabricated using metallic lithium as the counter electrode, Celgard 2400 as the separator, and 1M LiPF₆/EC+DEC as the electrolyte, and it was measured with its electrochemical properties. FIG. 11 is the initial charge-discharge curve of the button cell. The nano-silicon agglomerate composite negative electrode material prepared in Example 4 has an initial discharge capacity per gram of 2,935.2 mAh/g, and an initial coulombic efficiency of 84.9%. The button cell was cycled for 120 times through 1C charge-discharge cycle, and the charge capacity was not decayed, but slightly increased.

### Example 5

5 kg of 200-mesh magnesium powder with a carbon content of 1.0% were taken, and the temperature of a stirring boiling furnace was set to 850° C. A spiral feeder was used to feed the above carbon-containing magnesium powder into the boiling furnace at a constant feeding speed of 1 kg/h. 17.5 kg of analytically pure silicon tetrachloride were added into a silicon tetrachloride volatilizer, and the volatilizer was heated in a water bath set at the temperature of 56° C., which is close to the boiling point 57.6° C. of the silicon tetrachloride. An argon gas with a high purity of 99.995% was supplied into the silicon tetrachloride volatilizer in order to carry the gaseous silicon tetrachloride into the boiling furnace. By adjusting the flow rate of the carrier argon gas, the feeding speed of the silicon tetrachloride was controlled to be 3.5 kg/h. The rotational speed of the stirring blade of the stirring boiling furnace was set at 120 rpm. The boiling furnace was maintained at a positive pressure of 1,800 Pa, and when the pressure was higher than the positive pressure, an electromagnetic valve arranged at the chimney was automatically opened. Products were continuously and spirally discharged from the lower part of the boiling furnace. After reactions were performed for 3 hours with continuous feeding, the discharge was started to obtain a dark yellow-green powder containing a small amount of magnesium chloride. What was formed was a nano-silicon agglomerate of pine needle and branch-shaped three-dimensional network structure, wherein the silicon nanowires had a diameter of about 70 nm and a length of about 1 μm. The X-ray diffraction spectrum showed that the powder was crystalline silicon. The small amount of carbon as the core particles, for the low amount, was not detected due to the limitation of the sensitivity of X-ray diffraction meter. A carbon analyzer was used to measure the carbon content to be 1.77%. The prepared agglomerate powder was measured with a laser particle size analyzer to have a particle size distribution: D10=4.5 μm, D50=9.1 μm, D90=12.0 μm.

The above powder was sprayed with a dispersion of propyl zirconate/starch in ethanol, and after being dried by baking in vacuum, it was added into a vacuum furnace. The furnace was charged with a highly pure argon gas, then heated to 500° C., further evacuated to 100 Pa, and further heated to 700° C. The temperature was then kept for 4 hours so that the small amount of magnesium chloride was completely removed by evacuation. Meanwhile, the propyl zirconate was cracked into zirconium dioxide, and the starch was cracked into carbon. The zirconium dioxide and the carbon were coated over the nano-silicon agglomerates of pine needle and branch-shaped three-dimensional network structure, to produce a composite negative electrode material, wherein the amounts of the zirconium dioxide and carbon for surface coating and the inner core carbon particles were 1.0%, 1.1%, and 1.73% respectively.

0.4 g of SuperP electrically conductive carbon powder, 15 g of a polyamide acid-based binder (with a solid content of 14.2%), 27 g of a carbon nanotube/graphene mixed slurry (with a solid content of 5.6%), and 15 g of the above prepared composite negative electrode material, by adding N-methylpyrrolidone, were stirred to obtain a uniform slurry with a viscosity of 3,800 mPa·s. The slurry was coated on a 10 μm copper foil. The coating layer had a wet thickness of 150 μm, and it was vacuum dried by baking at 100° C., rolled, and subjected to imidization at 290° C. for 30 minutes in an argon atmosphere. Then, a CR2032 button cell was fabricated using metallic lithium as the counter electrode, Celgard 2400 as the separator, and 1M LiPF₆/EC+DEC as the electrolyte, and it was measured with its electrochemical properties. FIG. 12 is the initial charge-discharge curve of the button cell prepared in Example 5. The nano-silicon agglomerate composite negative electrode material prepared in Example 5 has an initial discharge capacity per gram of 2,806.8 mAh/g, and an initial coulombic efficiency of 85.1%. The button cell was cycled for 120 times through 1C charge-discharge cycle, and the charge capacity was not decayed.

### Example 6

5 kg of 200-mesh magnesium powder with a carbon content of 1.6% were taken, and the temperature of a stirring boiling furnace was set to 950° C. A spiral feeder was used to feed the above carbon-containing magnesium powder into the boiling furnace at a constant feeding speed of 1 kg/h. 17.5 kg of analytically pure silicon tetrachloride were added into a silicon tetrachloride volatilizer, and the volatilizer was heated in a water bath set at the temperature of 56° C., which is close to the boiling point 57.6° C. of the silicon tetrachloride. An argon gas with a high purity of 99.995% was supplied into the silicon tetrachloride volatilizer in order to carry the gaseous silicon tetrachloride into the boiling furnace. By adjusting the flow rate of the carrier argon gas, the feeding speed of the silicon tetrachloride was controlled to be 3.5 kg/h. The rotational speed of the stirring blade of the stirring boiling furnace was set at 200 rpm. The boiling furnace was maintained at a positive pressure of 1,800 Pa, and when the pressure was higher than the positive pressure, an electromagnetic valve arranged at the chimney was automatically opened. Products were continuously and spirally discharged from the lower part of the boiling furnace. After reactions were performed for 3 hours with continuous feeding, the discharge was started to obtain a dark yellow-green powder containing a small amount of magnesium chloride. What was formed was a nano-silicon agglomerate of pine needle and branch-shaped three-dimensional network structure, wherein the silicon nanowires had a diameter of about 50 nm and a length of about 0.5 μm. The X-ray diffraction spectrum showed that the powder was crystalline silicon. The small amount of carbon as the core particles, for the low amount, was not detected due to the limitation of the sensitivity of X-ray diffraction meter. A carbon analyzer was used to measure the carbon content to be 2.8%. The prepared agglomerate powder was measured with a laser particle size analyzer to have a particle size distribution: D10=4.1 μm, D50=8.9 μm, D90=11.7 μm.

The above powder was sprayed with a dispersion of propyl zirconate, butyl titanate/starch in ethanol, and after being dried by baking in vacuum, it was added into a vacuum furnace. The furnace was charged with a highly pure argon gas, then heated to 500° C., further evacuated to 100 Pa, and further heated to 700° C. The temperature was then kept for 4 hours so that the small amount of magnesium chloride was completely removed by evacuation. Meanwhile, the propyl zirconate was cracked into zirconium dioxide, the butyl titanate was cracked into titanium dioxide, and the starch was cracked into carbon. The zirconium dioxide, the titanium dioxide and the carbon were coated over the nano-silicon agglomerates of pine needle and branch-shaped three-dimensional network structure, to produce a composite negative electrode material, wherein the amounts of the zirconium dioxide, titanium dioxide and carbon for surface coating and the inner core carbon particles were 1.6%, 1.4%, 1.0%, and 2.7% respectively.

0.4 g of SuperP electrically conductive carbon powder, 15 g of a polyamide acid-based binder (with a solid content of 14.2%), 27 g of a carbon nanotube/graphene mixed slurry (with a solid content of 5.6%), and 15 g of the above prepared composite negative electrode material, by adding N-methylpyrrolidone, were stirred to obtain a uniform slurry with a viscosity of 3,800 mPa·s. The slurry was coated on a 10 μm copper foil. The coating layer had a wet thickness of 150 μm, and it was vacuum dried by baking at 100° C., rolled, and subjected to imidization at 290° C. for 30 minutes in an argon atmosphere. Then, a CR2032 button cell was fabricated using metallic lithium as the counter electrode, Celgard 2400 as the separator, and 1M LiPF₆/EC+DEC as the electrolyte, and it was measured with its electrochemical properties. The button cell has an initial discharge capacity per gram of 2,602.6 mAh/g, and an initial coulombic efficiency of 85.0%. The button cell had good cycling performances, and after first 100 cycles, no capacity-decaying phenomena occurred.

### Example 7

10 kg of 100-mesh zinc powder with a purity of 99.9% were added into 10 L of a 0.05 M silver nitrate solution, and they were stirred for 15 minutes at 10° C. and left to stand for 0.5 hour. Then, the underlying material was taken out, and it is centrifugally dried and then vacuum dried by baking at 80° C., to produce zinc powder coated with silver on a part of the surface, with a silver content of 0.54 wt %. The temperature of a stirring boiling furnace was set to 500° C. A spiral feeder was used to feed the above prepared silver-coated zinc powder into the boiling furnace at a constant feeding speed of 2 kg/h. 13 kg of analytically pure silicon tetrachloride were added into a silicon tetrachloride volatilizer, and the volatilizer was heated in a water bath set at the temperature of 55° C., which is close to the boiling point 57.6° C. of the silicon tetrachloride. An argon gas with a high purity of 99.995% was supplied into the silicon tetrachloride volatilizer in order to carry the gaseous silicon tetrachloride into the boiling furnace. By adjusting the flow rate of the carrier argon gas, the feeding speed of the silicon tetrachloride was controlled to be 2.6 kg/h. The rotational speed of the stirring blade of the stirring boiling furnace was set at 20 rpm. The boiling furnace was maintained at a positive pressure of 1,500 Pa, and when the pressure was higher than the positive pressure, an electromagnetic valve arranged at the chimney was automatically opened. Products were continuously and spirally discharged from the lower part of the boiling furnace. After reactions were performed for 3 hours with continuous feeding, the discharge was started to obtain a dark yellow-green powder containing a small amount of zinc chloride. With measurements, it was shown that the powder was a micron-sized agglomerate of pine needle and branch-shaped three-dimensional network structure formed with silicon nanowires, wherein the silicon nanowires had a diameter of about 150 nm and a length of about 2 μm. The powder had a particle size distribution: D10=7.5 μm, D50=13.8 μm, D90=19.5 μm.

The above powder was sprayed with a dispersion of butyl titanate/carboxymethyl cellulose in ethanol, and after being dried by baking in vacuum, it was added into a vacuum furnace. The furnace was charged with a highly pure argon gas, then heated to 500° C., further evacuated to 100 Pa, and further heated to 700° C. The temperature was then kept for 4 hours so that the small amount of zinc chloride was completely removed by evacuation. Meanwhile, the butyl titanate was cracked into titanium dioxide, and the carboxymethyl cellulose was cracked into carbon. The titanium dioxide and the carbon were coated over the nano-silicon agglomerates of pine needle and branch-shaped three-dimensional network structure, to produce a composite negative electrode material, wherein the amounts of the titanium dioxide and carbon for surface coating and the inner core silver particles were 2.5%, 4.5% and 2.4% respectively.

0.4 g of SuperP electrically conductive carbon powder, 15 g of a polyamide acid-based binder (with a solid content of 14.2%), 27 g of a carbon nanotube/graphene mixed slurry (with a solid content of 5.6%), and 15 g of the above prepared composite negative electrode material, by adding N-methylpyrrolidone, were stirred to obtain a uniform slurry with a viscosity of 3,800 mPa·s. The slurry was coated on a 10 μm copper foil. The coating layer had a wet thickness of 150 μm, and it was vacuum dried by baking at 100° C., rolled, and subjected to imidization at 290° C. for 30 minutes in an argon atmosphere. Then, a CR2032 button cell was fabricated using metallic lithium as the counter electrode, Celgard 2400 as the separator, and 1M LiPF₆/EC+DEC as the electrolyte, and it was measured with its electrochemical properties. The button cell had an initial discharge capacity per gram of 2,853.2 mAh/g, and an initial coulombic efficiency of 86.9%. The button cell was cycled for 80 times through 1C charge-discharge cycle, and the charge capacity was hardly decayed.

### Example 8

10 kg of 100-mesh zinc powder with a purity of 99.9% were added into 10 L of a 0.05 M ferrous sulfate solution, and they were stirred for 20 minutes at 2° C. and left to stand for 1 hour. Then, the underlying material was taken out, and it is centrifugally dried and then vacuum dried by baking at 80° C., to produce zinc powder coated with iron on a part of the surface, with an iron content of 0.28 wt %. The temperature of a stirring boiling furnace was set to 650° C. A spiral feeder was used to feed the above prepared iron-coated zinc powder into the boiling furnace at a constant feeding speed of 2 kg/h. 13 kg of analytically pure silicon tetrachloride were added into a silicon tetrachloride volatilizer, and the volatilizer was heated in a water bath set at the temperature of 55° C., which is close to the boiling point 57.6° C. of the silicon tetrachloride. An argon gas with a high purity of 99.995% was supplied into the silicon tetrachloride volatilizer in order to carry the gaseous silicon tetrachloride into the boiling furnace. By adjusting the flow rate of the carrier argon gas, the feeding speed of the silicon tetrachloride was controlled to be 2.6 kg/h. The rotational speed of the stirring blade of the stirring boiling furnace was set at 100 rpm. The boiling furnace was maintained at a positive pressure of 1,500 Pa, and when the pressure was higher than the positive pressure, an electromagnetic valve arranged at the chimney was automatically opened. Products were continuously and spirally discharged from the lower part of the boiling furnace. After reactions were performed for 3 hours with continuous feeding, the discharge was started to obtain a dark yellow-green powder containing a small amount of zinc chloride. The SEM photograph showed that the dark yellow-green powder was a micron-sized agglomerate of pine needle and branch-shaped three-dimensional network structure formed with silicon nanowires, wherein the silicon nanowires had a diameter of about 90 nm and a length of about 1 μm. The prepared agglomerate powder had a particle size distribution: D10=5.2 μm, D50=9.5 μm, D90=12.3 μm.

The above powder was sprayed with a dispersion of butyl zirconate/carboxymethyl cellulose in ethanol, and after being dried by baking in vacuum, it was added into a vacuum furnace. The furnace was charged with a highly pure argon gas, then heated to 500° C., further evacuated to 100 Pa, and further heated to 750° C. The temperature was then kept for 4 hours so that the small amount of zinc chloride was completely removed by evacuation. Meanwhile, the butyl zirconate was cracked into zirconium dioxide, and the carboxymethyl cellulose was cracked into carbon. The zirconium dioxide and the carbon were coated over the nano-silicon agglomerates of pine needle and branch-shaped three-dimensional network structure, to produce a composite negative electrode material, wherein the amounts of the zirconium dioxide and carbon for surface coating and the inner core iron particles were 1.2%, 1.5% and 1.2% respectively.

0.4 g of SuperP electrically conductive carbon powder, 15 g of a polyamide acid-based binder (with a solid content of 14.2%), 27 g of a carbon nanotube/graphene mixed slurry (with a solid content of 5.6%), and 15 g of the above prepared composite negative electrode material, by adding N-methylpyrrolidone, were stirred to obtain a uniform slurry with a viscosity of 3,800 mPa·s. The slurry was coated on a 10 μm copper foil. The coating layer had a wet thickness of 150 μm, and it was vacuum dried by baking at 100° C., rolled, and subjected to imidization at 290° C. for 30 minutes in an argon atmosphere. Then, a CR2032 button cell was fabricated using metallic lithium as the counter electrode, Celgard 2400 as the separator, and 1M LiPF₆/EC+DEC as the electrolyte, and it was measured with its electrochemical properties. The nano-silicon agglomerate composite negative electrode material prepared in Example 8 had an initial discharge capacity per gram of 2,732 mAh/g, and an initial coulombic efficiency of 86.3%. The button cell was cycled for 100 times through 1C charge-discharge cycle, and the capacity had a retention rate of 97.5%.

### Example 9

10 kg of 100-mesh zinc powder with a purity of 99.9% were added into 10 L of a mixed solution of 0.05 M nickel sulfate and 0.05 cobalt sulfate, and they were stirred for 20 minutes at 1° C. and left to stand for 1 hour. Then, the underlying material was taken out, and it is centrifugally dried and then vacuum dried by baking at 80° C., to produce zinc powder coated with nickel and cobalt on a part of the surface, with a nickel content of 0.29 wt % and a cobalt content of 0.29 wt %. The temperature of a stirring boiling furnace was set to 650° C. A spiral feeder was used to feed the above prepared nickel and cobalt-coated zinc powder into the boiling furnace at a constant feeding speed of 2 kg/h. 13 kg of analytically pure silicon tetrachloride were added into a silicon tetrachloride volatilizer, and the volatilizer was heated in a water bath set at the temperature of 55° C., which is close to the boiling point 57.6° C. of the silicon tetrachloride. An argon gas with a high purity of 99.995% was supplied into the silicon tetrachloride volatilizer in order to carry the gaseous silicon tetrachloride into the boiling furnace. By adjusting the flow rate of the carrier argon gas, the feeding speed of the silicon tetrachloride was controlled to be 2.6 kg/h. The rotational speed of the stirring blade of the stirring boiling furnace was set at 100 rpm. The boiling furnace was maintained at a positive pressure of 1,500 Pa, and when the pressure was higher than the positive pressure, an electromagnetic valve arranged at the chimney was automatically opened. Products were continuously and spirally discharged from the lower part of the boiling furnace. After reactions were performed for 3 hours with continuous feeding, the discharge was started to obtain a dark yellow-green powder containing a small amount of zinc chloride. The SEM photograph showed that the dark yellow-green powder is a micron-sized agglomerate of pine needle and branch-shaped three-dimensional network structure formed with silicon nanowires, wherein the silicon nanowires had a diameter of about 100 nm and a length of about 1 μm. The prepared agglomerate powder had a particle size distribution: D10=5.1 μm, D50=9.3 μm, D90=12.1 μm.

The above powder was sprayed with a dispersion of butyl zirconate/carboxymethyl cellulose in ethanol, and after being dried by baking in vacuum, it was added into a vacuum furnace. The furnace was charged with a highly pure argon gas, then heated to 500° C., further evacuated to 100 Pa, and further heated to 750° C. The temperature was then kept for 4 hours so that the small amount of zinc chloride was completely removed by evacuation. Meanwhile, the butyl zirconate was cracked into zirconium dioxide, and the carboxymethyl cellulose was cracked into carbon. The zirconium dioxide and the carbon were coated over the nano-silicon agglomerate of pine needle and branch-shaped three-dimensional network structure, to produce a composite negative electrode material, wherein the amounts of the zirconium dioxide and carbon for surface coating and the inner core nickel and cobalt particles were 1.2%, 1.5%, 1.3% and 1.3% respectively.

0.4 g of SuperP electrically conductive carbon powder, 15 g of a polyamide acid-based binder (with a solid content of 14.2%), 27 g of a carbon nanotube/graphene mixed slurry (with a solid content of 5.6%), and 15 g of the above prepared composite negative electrode material, by adding N-methylpyrrolidone, were stirred to obtain a uniform slurry with a viscosity of 3,800 mPa·s. The slurry was coated on a 10 μm copper foil. The coating layer had a wet thickness of 150 μm, and it was vacuum dried by baking at 100° C., rolled, and subjected to imidization at 290° C. for 30 minutes in an argon atmosphere. Then, a CR2032 button cell was fabricated using metallic lithium as the counter electrode, Celgard 2400 as the separator, and 1M LiPF₆/EC+DEC as the electrolyte, and it was measured with its electrochemical properties. The nano-silicon agglomerate composite negative electrode material prepared in Example 9 had an initial discharge capacity per gram of 2,673 mAh/g, and an initial coulombic efficiency of 86.4%. The button cell was cycled for 100 times through 1C charge-discharge cycle, and the capacity had a retention rate of 98.2%.

### Comparative Example 1

10 kg of 200-mesh zinc powder with a purity of 99.9% were taken, and the temperature of a stirring boiling furnace was set to 550° C. A spiral feeder was used to feed the above zinc powder into the boiling furnace at a constant feeding speed of 2 kg/h. 13 kg of analytically pure silicon tetrachloride were added into a silicon tetrachloride volatilizer, and the volatilizer was heated in a water bath set at the temperature of 55° C., which is close to the boiling point 57.6° C. of the silicon tetrachloride. An argon gas with a high purity of 99.995% was supplied into the silicon tetrachloride volatilizer in order to carry the gaseous silicon tetrachloride into the boiling furnace. By adjusting the flow rate of the carrier argon gas, the feeding speed of the silicon tetrachloride was controlled to be 2.6 kg/h. The rotational speed of the stirring blade of the stirring boiling furnace was set at 60 rpm. The boiling furnace was maintained at a positive pressure of 1,500 Pa, and when the pressure was higher than the positive pressure, an electromagnetic valve arranged at the chimney was automatically opened. Products were continuously and spirally discharged from the lower part of the boiling furnace. After reactions were performed for 3 hours with continuous feeding, the discharge was started. Through the experiment, it was found that no powder was discharged. After the apparatus was opened, some adhesions were found on inner walls of stainless steel muffle tank, stirring blades, and stirring shaft of the stirring boiling furnace. Some adhesions, after being scraped, were found to be yellow. The SEM observations (see. FIG. 13) showed that the adhesions are nano silicon powder and a small quantity of nanowires. The silicon nanowires were loose, and no three-dimensional network nano-silicon agglomerate was formed, and the yield of the silicon nanowire was very low.

In comparison with Example 1, Comparative Example 1 lacked silver produced on the surface of zinc powder through a replacement reaction. In Example 1, ultrafine and highly dispersed silver particles, with the zinc particles, were stirred in a stirring boiling furnace to suspend and rotate, and after the zinc was rapidly volatilized, the ultrafine silver particles in the gas phase became a nucleating agent for silicon. Due to high-speed rotation and dynamic growth, a nano-silicon agglomerate of pine needle and branch-shaped three-dimensional network structure was formed. However, in Comparative Example 1, such nucleating agent was absent, and a minority of silicon only grew on the inner walls, stirring blades and stirring shaft of the reactor, and a majority of the silicon cannot grew in time so that they were discharged from the chimney.

### Comparative Example 2

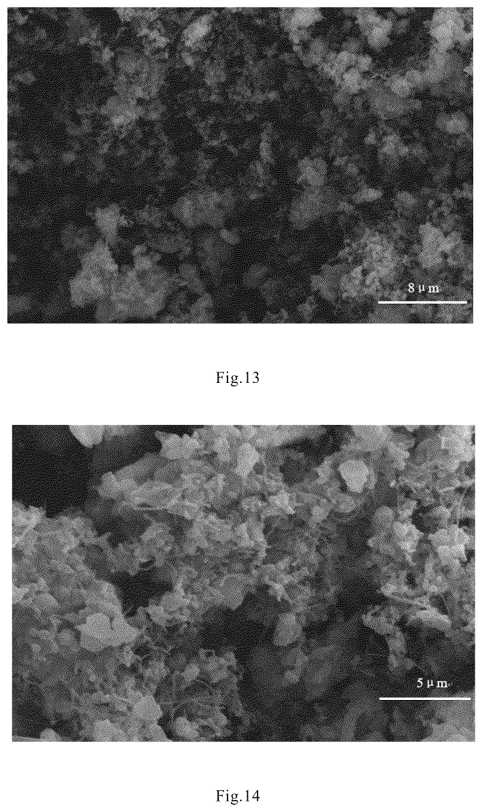

10 kg of 200-mesh zinc powder with a purity of 99.9% were mixed with 54 g of silver powder having a particle size of 60 nm. The silver content of the mixed powder is 0.54 wt %. The temperature of a stirring boiling furnace was set to 550° C. A spiral feeder was used to feed the above zinc powder into the boiling furnace at a constant feeding speed of 2 kg/h. 13 kg of analytically pure silicon tetrachloride were added into a silicon tetrachloride volatilizer, and the volatilizer was heated in a water bath set at the temperature of 55° C., which is close to the boiling point 57.6° C. of the silicon tetrachloride. An argon gas with a high purity of 99.995% was supplied into the silicon tetrachloride volatilizer in order to carry the gaseous silicon tetrachloride into the boiling furnace. By adjusting the flow rate of the carrier argon gas, the feeding speed of the silicon tetrachloride was controlled to be 2.6 kg/h. The rotational speed of the stirring blade of the stirring boiling furnace was set at 60 rpm. The boiling furnace was maintained at a positive pressure of 1,500 Pa, and when the pressure was higher than the positive pressure, an electromagnetic valve arranged at the chimney was automatically opened. Products were continuously and spirally discharged from the lower part of the boiling furnace. After reactions were performed for 3 hours with continuous feeding, the discharge was started. Through the experiment, it was found that little powder was discharged. The discharge quantity is 1/10 of the discharge quantity in Example 1. As observed with SEM, the powder comprised silver powder and silicon nanowires, whereas no silicon nanowire cluster was formed. After the apparatus was opened, some adhesions were found on inner walls of stainless steel muffle tank, stirring blades, and stirring shaft of the stirring boiling furnace. Some adhesions, after being scraped, were found to be yellow. The SEM observations (see. FIG. 14) showed that the adhesions are nano silicon powder and a small quantity of nanowires. The silicon nanowires were loose, and no three-dimensional network nano-silicon agglomerate was formed, and the yield of the silicon nanowire was very low.

In comparison with Example 1, the raw materials of Comparative Example 2 contained silver in the same mass. However, in Example 1, 54 g of silver were produced on the surface of 10 kg of zinc powder through the replacement reaction, and 54 g of the silver were highly dispersed on the surface of 10 kg of the zinc powder. In contrast, in Comparative Example 2, 10 kg of zinc powder was added with 54 g of nano silver powder by conventional mixing, and the dispersion state of the silver is far inferior to that in Example 1. The nano silver of Comparative Example 2, as a nucleating agent, was less. Meanwhile, since the silver particles were heavy, they were not easily stirred to suspend in the space of the reactor, and thus they cannot be effectively used as the nucleating agent for silicon growth.

1. A nano-silicon agglomerate composite negative electrode material, characterized in that it comprises nano-sized core particles, a nano-silicon agglomerate of pine needle and branch-shaped three-dimensional network structure growing around the nano-sized core particles, and a composite coating layer over the nano-silicon agglomerate of pine needle and branch-shaped three-dimensional network structure, wherein the nano-sized core particles comprise metal particles and/or carbon particles; the nano-silicon agglomerate of pine needle and branch-shaped three-dimensional network structure is formed by interconnected silicon nanowires having a diameter of 50 to 150 nm and a length of 0.5 to 2 μm; and the composite coating layer comprises electrically conductive carbon and an inorganic metal oxide.

2. The nano-silicon agglomerate composite negative electrode material according to claim 1, characterized in that the metal particles are particles of at least one selected from the group consisting of silver, copper, iron, nickel, and cobalt.

3. The nano-silicon agglomerate composite negative electrode material according to claim 1, characterized in that the inorganic metal oxide includes titanium dioxide and/or zirconium dioxide.

4. The nano-silicon agglomerate composite negative electrode material according to claim 1, characterized in that based on the weight of the nano-silicon agglomerate composite negative electrode material, the nano-silicon agglomerate of pine needle and branch-shaped three-dimensional network structure is present in an amount of 90.6 to 96.17 wt %.

5. The nano-silicon agglomerate composite negative electrode material according to claim 1, characterized in that based on the weight of the nano-silicon agglomerate composite negative electrode material, the nano-sized core particles are present in an amount of 1.4 to 3.3% by weight, wherein the metal particles are present in an amount of 0 to 2.6% by weight, and the carbon particles are present in an amount of 0 to 2.7% by weight.

6. The nano-silicon agglomerate composite negative electrode material according to claim 1, characterized in that based on the weight of the nano-silicon agglomerate composite negative electrode material, the composite coating layer is present in an amount of 2.1 to 7.0% by weight, wherein in the composite coating layer, the electrically conductive carbon is present in an amount of 1.0 to 4.5% by weight, and the inorganic metal oxide is present in an amount of 1.0 to 3.0% by weight.

7. The nano-silicon agglomerate composite negative electrode material according to claim 1, characterized in that the nano-silicon agglomerate composite negative electrode material has an average particle size of 5 to 20 μm.

8. A method for preparing a nano-silicon agglomerate composite negative electrode material, characterized in that it comprises the following steps:
(1) performing a surface metal replacement reaction by placing a powder of metal A in a salt solution of metal B, to produce nano-sized metal B particles on a part of the surface of the powder of metal A, thereby forming a composite powder;
(2) continuously charging the composite powder serving as a reactant and a nucleating agent into a reaction chamber;
(3) carrying a SiCl4 gas into the reaction chamber with inert gas or nitrogen;
(4) performing a high temperature reaction with continuous stirring by setting the temperature of the reaction chamber to be 500 to 950° C., the reaction causing a nano-silicon agglomerate of pine needle and branch-shaped three-dimensional network structure to dynamically grow and wind around the nano-sized metal B particles;
(5) subjecting the nano-silicon agglomerate of pine needle and branch-shaped three-dimensional network structure discharged from the reaction chamber to a vacuum thermal treatment; and
(6) subjecting the nano-silicon agglomerate of pine needle and branch-shaped three-dimensional network structure obtained in step (5) to a composite coating treatment with electrically conductive carbon and an inorganic metal oxide.

9. The method according to claim 8, characterized in that in step (1), the surface metal replacement reaction is performed by placing an alloy powder comprising metal A and carbon in the salt solution of metal B; on a part of the surface of the alloy powder, the nano-sized metal B particles are generated, to form a composite powder; in step (4), the reaction causes the nano-silicon agglomerate of pine needle and branch-shaped three-dimensional network structure to dynamically grow and wind around the nano-sized carbon particles produced by the alloy powder and around the nano-sized metal B particles.

10. The method according to claim 8, characterized in that the metal A is at least one selected from the group consisting of magnesium and zinc, and the metal B is at least one selected from the group consisting of silver, copper, iron, nickel, and cobalt.

11. The method according to claim 8, characterized in that the inorganic metal oxide includes titanium dioxide and/or zirconium dioxide.

12. The method according to claim 8, characterized in that the vacuum thermal treatment of step (5) and the composite coating treatment of step (6) are performed simultaneously.

13. A Method for preparing a nano-silicon agglomerate composite negative material, characterized in that it comprises the following steps:
(1) continuously charging an alloy powder comprising metal A and carbon and serving as a reactant and a nucleating agent into a reaction chamber;
(2) carrying a SiCl4 gas into the reaction chamber with inert gas or nitrogen;
(3) performing a high temperature reaction with continuous stirring by setting the temperature of the reaction chamber to be 500 to 950° C., the reaction causing a nano-silicon agglomerate of pine needle and branch-shaped three-dimensional network structure to dynamically grow and wind around the nano-sized carbon particles produced by the alloy powder;
(4) subjecting the nano-silicon agglomerate of pine needle and branch-shaped three-dimensional network structure discharged from the reaction chamber to a vacuum thermal treatment; and
(5) subjecting the nano-silicon agglomerate of pine needle and branch-shaped three-dimensional network structure obtained in step (4) to a composite coating treatment with electrically conductive carbon and an inorganic metal oxide.

14. The method according to claim 13, characterized in that: the metal A is at least one selected from the group consisting of magnesium and zinc.

15. The method according to claim 13, characterized in that the inorganic metal oxide includes titanium dioxide and/or zirconium dioxide.

16. The method according to claim 13, characterized in that: the vacuum thermal treatment of step (4) and the composite coating treatment of step (5) are performed simultaneously.

17. The nano-silicon agglomerate composite negative electrode material according to claim 2, characterized in that the inorganic metal oxide includes titanium dioxide and/or zirconium dioxide.

18. The nano-silicon agglomerate composite negative electrode material according to claim 2, characterized in that based on the weight of the nano-silicon agglomerate composite negative electrode material, the nano-silicon agglomerate of pine needle and branch-shaped three-dimensional network structure is present in an amount of 90.6 to 96.17 wt %.

19. The nano-silicon agglomerate composite negative electrode material according to claim 2, characterized in that based on the weight of the nano-silicon agglomerate composite negative electrode material, the nano-sized core particles are present in an amount of 1.4 to 3.3% by weight, wherein the metal particles are present in an amount of 0 to 2.6% by weight, and the carbon particles are present in an amount of 0 to 2.7% by weight.

20. The nano-silicon agglomerate composite negative electrode material according to claim 2, characterized in that based on the weight of the nano-silicon agglomerate composite negative electrode material, the composite coating layer is present in an amount of 2.1 to 7.0% by weight, wherein in the composite coating layer, the electrically conductive carbon is present in an amount of 1.0 to 4.5% by weight, and the inorganic metal oxide is present in an amount of 1.0 to 3.0% by weight.
